(19) United States
(12) Patent Application Publication
(10) Pub. No.: US 2016/0125142 A1
(43) Pub. Date: May 5, 2016

(54) Interactive Electronic Health Record System for Retrieving, Reviewing, and Updating Health Records at the Point of Care

(71) Applicant: Omar Awad, Dallas, TX (US)

(72) Inventor: Omar Awad, Dallas, TX (US)

(21) Appl. No.: 14/533,258

(22) Filed: Nov. 5, 2014

(51) Int. Cl. G06F 19/00; G06F 3/0484; G06F 17/22

(52) U.S. Cl. CPC G06F 19/322; G06F 17/2247; G06F 3/0484

(57) ABSTRACT

An interactive and intelligent electronic health record system which allows a healthcare provider to review and directly interact with patient data in real-time at the point of care without navigating to another portion of the electronic health record. A healthcare provider may directly interact with data presented for review in an electronic health record by interacting with the respective data field and ordering or updating a patient's treatment regimen from within the medical tests results screen within the patient's electronic health record at the point of care. Real-time interaction with the results displayed in an electronic health record improves efficiency and care provided by physicians by preventing mental lapses, duplicative orders, and possible omissions. The system provides status indicators within a patient's updated electronic health record to show that a data value has been addressed or is currently being addressed, preventing duplicative orders and improving the healthcare administered to patients.

### CROSS-REFERENCE TO RELATED APPLICATIONS

None.

### TECHNICAL FIELD

The present invention is generally a system and method for retrieving, reviewing, and updating an interactive electronic health record directly within a physician's workflow at the point of care.

### BACKGROUND

Traditionally, patient medical records consisted of a file with various papers, patient history, medical charts, test results, and notes of medical providers. Traditional paper files have numerous short comings which are not complementary to advances in technology. Paper files may be easily misplaced, are difficult to share between medical facilities, and must be deconstructed for copying. The medical field has encouraged the adaption of Electronic Health Records (EHR) since computer-based systems would likely enhance care, expedite treatment of patients, decrease medical errors, and improve communications between medical professionals and patients.

Unfortunately, the transition to EHRs has not been as seamless or successful as initially anticipated. In fact, the use of EHRs has increased medical costs, complicated the health care system, and failed to adequately reduce medical errors, as desired. Current EHRs are encumbered with the legacy of the paper medical records and charts. Current EHRs simply increase the amount of redundant data without enhancing workflow for medical care providers. In fact, many medical care providers feel that current EHRs actually complicate, and potentially disrupt, a healthcare provider's workflow. Presently, many EHRs merely allow healthcare providers to review notes from previous providers, review lab results, and measure patient vital signs. After interviewing and examining a patient, the current healthcare provider would likely add his or her own notes to the file and enter orders for patient care. Some more advanced EHRs may allow healthcare providers to enter the orders within the EHR software. However, to enter orders for patient care or otherwise update a patient's EHR, present EHRs require healthcare providers to navigate to an entirely different portion of the EHR, away from the portion of the EHR which presents data for review. The gap of time between the initial data review and the order input may result in inaccuracies due to healthcare provider memory lapses, duplicate orders for labs, or medications. Accordingly, a need exists for an interactive EHR which analyzes data and recommends certain interventions, treatments, orders, and otherwise based on the results of said data; and further allows healthcare providers to instantaneously review and update a patient's treatment regimen in real-time at the point of care without navigating to another portion of the EHR.

To address the previously mentioned deficiencies, the present system is an intelligent EHR system which allows the healthcare provider to directly interact with data presented for review within an EHR without navigating to another portion of the EHR. In the present embodiment, a healthcare provider presented with healthcare data in the form of medical test results—such as lab results, culture results, hemodynamic data, vital signs, or otherwise—may review and directly interact with the data in real time. Additionally, the present system can enhance healthcare providers' treatment decisions by providing a healthcare provider with multiple treatment options known to address various medical issues. In the present embodiment, all review of and interactions with the data may be performed within the same EHR display without navigating to another portion of the EHR. The ability to interact with the data in real time ensures accurate and efficient treatment by negating memory lapses and the insertion of repetitive data.

### SUMMARY OF THE INVENTION

The present invention, generally, is an intelligent and interactive EHR platform which allows a healthcare provider to review and directly interact with patient data in real-time at the point of care. The present platform also allows users to review the status of patients' prior and current treatment and directly interact with patients' EHRs in real-time within the users' daily workflow. The present invention presents patient data in an EHR which can be reviewed and modified by healthcare providers with access to the medical records of respective patients. Moreover, interacting with patient data presented for review may prompt a contextual menu wherein a healthcare provider may select from an array of interventions, treatments, orders, and other similar treatment options which are specific to the interaction within the EHR. Accordingly, the present invention enables healthcare providers to interact with data presented for review and directly order intervention and treatment without navigating or transitioning to other portions of the EHR.

Generally, the present invention is an improved EHR which allows users to interact with and update a patient's EHR in real time directly within the data-review portion of the EHR. In the preferred embodiment of the present invention, the data presented for review is related to certain medical tests; including, but not limited to, lab results, culture results, or hemodynamic monitoring results. Accordingly, the data available for a specific patient may be reviewed and directly interacted with by a medical professional at the point of care during a patient visit, enhancing the workflow of the medical professional. Addressing a patient's needs with assistance from the EIIR in real time prevents potential gaps in medical care due to human error or memory lapses which may occur if notes are made after a patient leaves the point of care.

Furthermore, the present invention may provide healthcare providers with interactive and intelligent order-entry menus for addressing, managing, or correcting potential abnormalities in a patient's healthcare. In the preferred embodiment, interaction with a data field in a patient's EHR launches an interactive, order-entry menu wherein a healthcare provider may select a treatment option and update the patient's EHR in real-time. In the preferred embodiment, the present invention presents treatment options specifically tailored to addressing potential abnormalities determined through the present system's analysis. The treatment options may include, but are not limited to, alternative medications, dosages, and routes of administration. In the preferred embodiment—once a treatment has been selected—the data field indicates treatment is in process and temporarily locks the field from being updated further by a different healthcare provider to prevent duplicate order entries.

Additionally, the present invention may provide status indications relating to a patient's current treatment regimen or other information that may be important to the healthcare of the patient. For example, the present invention may indicate whether a patient is properly responding to specific medication or treatment, based on known resistances to certain organisms, and allow a healthcare provider to directly update the patient's medication or treatment regimen within the patient's EHR at the point of care. In the preferred embodiment, the present invention may also indicate whether a potential abnormality has been addressed or whether treatment is currently in process. By providing status indications, the present invention prevents healthcare providers from ordering duplicative treatments or missing a diagnosis or treatment altogether, leading to more reliable and consistent patient healthcare.

The present invention may also automatically transmit prescription information to pharmacies, whether inpatient or outpatient, once a specific treatment has been ordered. Patient pharmacy preferences are typically stored in the EHR. For example, when a healthcare provider orders a new medication for a patient, the present invention may automatically transmit the prescription to an inpatient or outpatient pharmacy to be filled without navigating to another portion of the EHR. The automatic transmittal of data streamlines the prescription process by allowing a healthcare provider to order a new prescription without navigating to another portion of the EHR. Alternatively, a patient's prescription may be directly sent to another peripheral device, such as a printer, for patients who prefer a hardcopy prescription.

These and other aspects, features, embodiments, and benefits of the present invention will become apparent from the following detailed written description of the preferred embodiments and aspects taken in conjunction with the following drawings, although variations and modifications thereto may be effected without departing from the scope of the disclosure.

### OBJECTS OF THE INVENTION

The primary objective of this invention is to provide an intelligent and interactive EHR platform which enables a healthcare provider to address patient health deficiencies by directly interacting with various data points throughout the platform to request a treatment regimen at the point of care in real-time.

Another objective of this invention is to minimize lapses in healthcare due to human memory lapses, requests for duplicative treatments, or failures to request treatment.

Another objective of this invention is to enhance a healthcare provider's workflow to provide more efficient patient care by streamlining the process for diagnosis, treatment and follow up with patients.

### BRIEF DESCRIPTION OF DRAWINGS

The accompanying drawings illustrate one or more embodiments and/or aspects of the disclosure. Together with the written description, these embodiments serve to explain the principles of the disclosure.

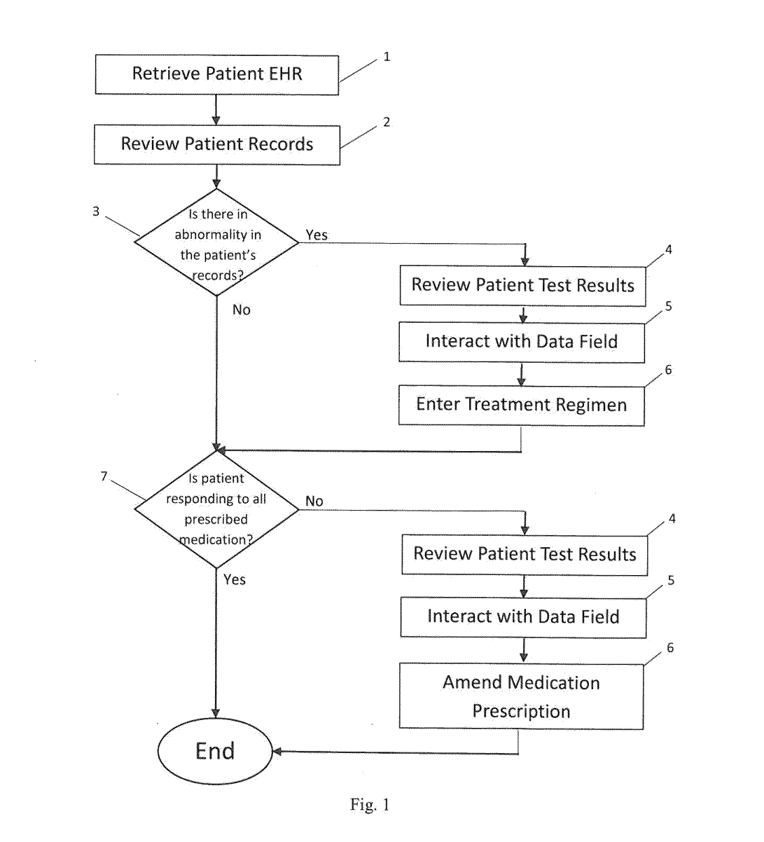

FIG. 1 is a flowchart of the preferred embodiment of the present invention.
Ref. 1 is a method step for retrieving a patient's EHR;
Ref. 2 is a method step for reviewing a patient's EHR;
Ref. 3 is a method step for determining abnormalities in a patient's records;
Ref. 4 is a method step for reviewing a patient's medical test results;
Ref. 5 is a method step for interacting with a data field within a medical test result screen;
Ref. 6 is a method step for entering a treatment regimen within a medical test result screen;
Ref. 7 is a method step for determining a patient's response to medication.

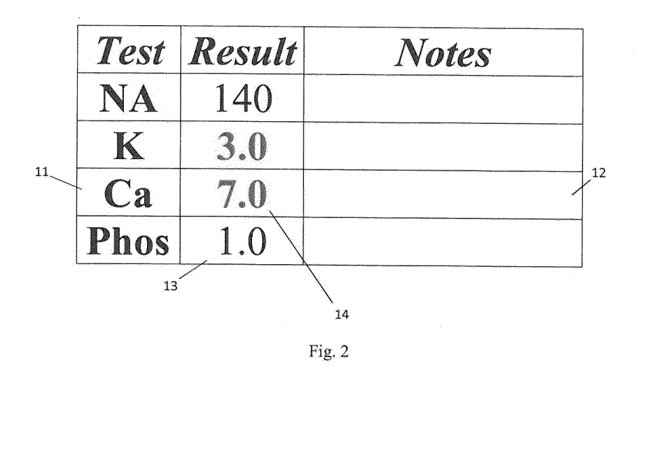

FIG. 2 illustrates a partial screen shot of an exemplary medical test result format in current EHRs;
Ref. 11 is a medical test identification data field;
Ref. 12 is a notes data field;
Ref. 13 is a medical test result data field;
Ref. 14 is notification means.

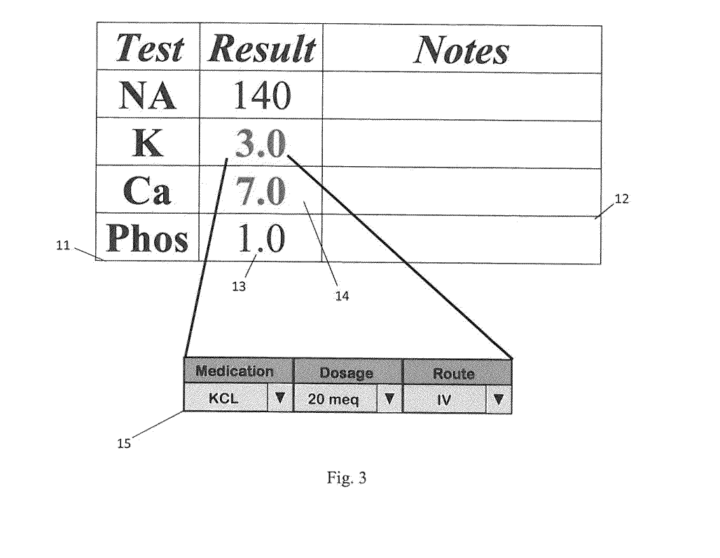

FIG. 3 illustrates a partial screen shot of an order-entry menu of the present invention;
Ref. 11 is a medical test identification data field;
Ref. 12 is a notes data field;
Ref. 13 is a medical test result data field;
Ref. 14 is notification means;
Ref. 15 is an order-entry menu.

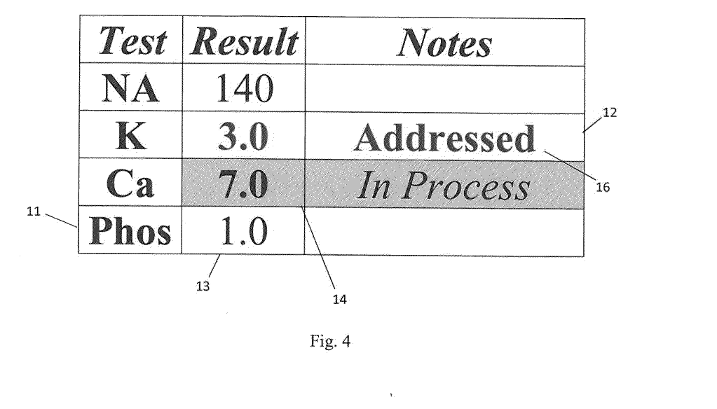

FIG. 4 illustrates a partial screen shot of a medical test result screen in the present invention with status indicators;
Ref. 11 is a medical test identification data field;
Ref. 12 is a notes data field;
Ref. 13 is a medical test result data field;
Ref. 14 is notification means;
Ref. 16 is a status indicator.

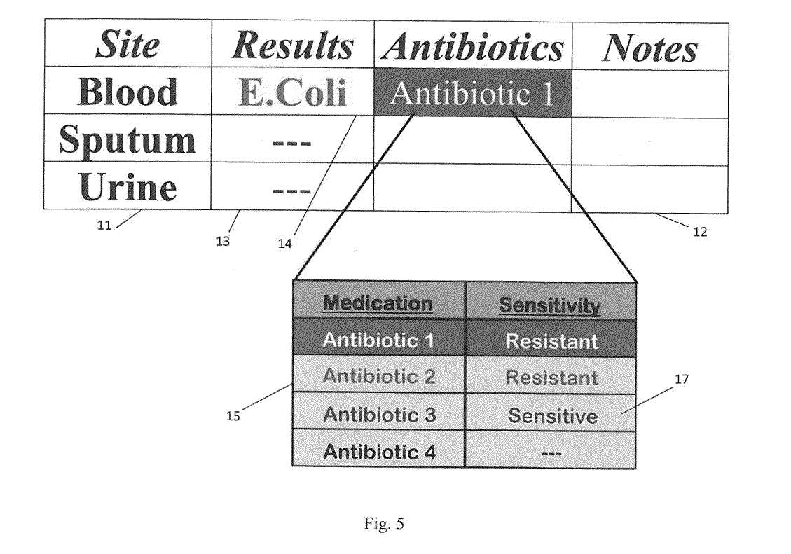

FIG. 5 illustrates a partial screen shot of a blood culture report in the present invention with medication-sensitivity indicators;
Ref. 11 is a medical test identification data field;
Ref. 12 is a notes data field;
Ref. 13 is a medical test result data field;
Ref. 14 is notification means;
Ref. 15 is an order-entry menu;
Ref. 17 is a medication-sensitivity indicator.

### DETAILED DESCRIPTION OF DRAWINGS

While the above description is of the preferred embodiment of the present invention, it should be appreciated that the invention may be modified, altered, or varied without deviating from the scope and fair meaning of the following description.

Referring generally to FIGS. 1-5, the embodiments of the present disclosure relate to an intelligent and interactive EHR which allows a healthcare provider to review and directly interact with patient data in real-time at the point of care. In the preferred embodiment of the present disclosure, the data presented for review in the patient's EHR is related to certain medical tests; including, but not limited to, lab results, culture results, or hemodynamic monitoring results. In the preferred embodiment of the present disclosure, a healthcare provider may interact with the data presented for review without navigating to another portion of the patient's EHR.

FIG. 1 shows a flow chart of the process involved with the present data-processing system. In the present embodiment, patient EHRs are stored in a secure database which can be accessed by multiple healthcare providers with proper login credentials. Through the shared, secure database, a healthcare provider may directly interact with data within a patient's EHR at the point of care by using a computer, tablet, cellular phone, or other similar electronic device. In the present embodiment, the data presented in a patient's EHR may be comprised of certain medical test results, such as blood test results, culture results, hemodynamic monitoring results, or other similar lab results.

FIG. 2 shows a partial screen shot of the exemplary format for data presentation in current EHRs. Generally, the data is presented in a standard medical test result format, wherein a healthcare provider can quickly determine whether the data shows any values that fall outside of the medically-accepted range for good health. Such values that fall outside of the medically-accepted range for good health are considered “abnormalities”. Many current EHRs are capable of automatically determining abnormalities through internal algorithms and comparison to the medically-accepted range for good health. Additionally, many current EHRs may notify healthcare providers of any abnormalities through notification means 14, such as changes in the font or data field. For example, if a test result 11 shows a potential abnormality, current EHRs may display the abnormal value in bold, red font to quickly draw a healthcare provider's attention to the abnormal value. Typically such notifications 14 remain visible until acknowledged and addressed by the user. Such a notification system 14 helps to ensure that no abnormalities are overlooked by a healthcare provider.

However, reports in current EHRs are limited to merely presenting information without allowing users to interact with the data presented for review within the EHR. Instead, current EHRs require users to navigate away from the data presented for review to order treatment regimens. The inability to interact with data presented for review within the report view of the EHR leads to potential gaps in medical care due to human error or memory lapses which may occur if notes are made after a patient leaves the point of care. The present invention solves this problem by allowing users to interact with data presented for review directly within a data field 13 in the medical test result screen of the EHR in real time at the point of care.

FIG. 3 shows a partial screen shot of an interactive order-entry menu 15 in the present invention. After an EHR analyzes data for potential abnormalities, the present invention allows healthcare providers to quickly address any abnormalities in real-time through interacting with the data filed 13 within the system's display. To address an abnormality, a healthcare provider may directly interact with a patient's EHR by accessing the data field 13 containing the abnormality. The healthcare provider will then be presented with an interactive order-entry menu 15 specifically tailored to addressing a specific abnormality, wherein the healthcare provider may select from a list of medications, dosages, and routes of administration commonly associated with the treatment of a particular abnormality.

FIG. 4 shows a partial screen shot of the exemplary medical test result screen in the present invention with status indicators 16. In the present invention, once a treatment regimen is ordered, the data field 13 with the original abnormality is updated and temporarily “locked” throughout the interaction to prevent duplicative and potentially contrasting orders by other healthcare providers. Additionally, the present invention may include status indicators 16 or visual cues to help healthcare providers quickly determine whether a potential abnormality has been addressed or is in the process of being addressed. For example, a data value presented for review which has already been addressed by a user may be displayed in green font to indicate that the data value was already addressed, whereas a data value that is currently being addressed may appear in a gray data field to indicate that the data value is locked for further editing. Additionally, in the preferred embodiment of the present invention, the status indicators 16 may provide other information relevant to the treatment of a patient. For example, if a medical test for a patient has been ordered, the status indicators 16 may show the name of an ordering physician and the date on which the ordering physician gave the order.

FIG. 5 shows a partial screen shot of a blood culture report in the present invention with medication-sensitivity indicators 17. In addition to the above, the present invention may also notify a healthcare provider if an organism doesn't respond to a particular medication. For example, if an organism is resistant to medication to which a patient is currently prescribed, the present invention notifies a healthcare provider of the resistance or sensitivity through notification means 14, such as changing colors of the font or data field 13 to indicate that the patient is resistant or sensitive to certain medication. The status indicators of the present invention help a healthcare provider quickly discern which medications are effective for a patient, producing more efficient healthcare for a patient. For example, when resistance to medication has been determined, the present invention may suggest alternative medications for that patient. Thereafter, a healthcare provider may request a new medication and treatment regimen within the patient's EIR by selecting the data field 13 for the medication without navigating to another portion of the EHR. Such an interaction directly orders, changes, and updates a patient's prescription all within the workflow of the treating healthcare provider without interrupting the review process, preventing potential human error memory lapses, which may negatively affect patient care.

The foregoing description of the embodiments of the present invention is not intended to be exhaustive or to limit the disclosure to the precise forms disclosed. Many modifications and variations of the present invention are possible in view of the above teaching. Alternative embodiments will become apparent to those of ordinary skill in the art to which the present disclosure pertains without departing from the spirit and scope of the present invention.

What is claimed:

1. A computer-implemented method wherein a healthcare provider can order a variety of medical treatments for a patient within a network of one or more healthcare providers directly within the workflow of a medical test result screen in an electronic health record, comprising:
(a) displaying, on an interface device, at least one medical test result associated with a patient in said healthcare provider's network, wherein said medical test result is comprised of one or more data fields;
(b) selecting at least one data field in said medical test result presented on said interface device for interaction within the workflow of said medical test result screen;
(c) displaying, on said interface device, a list of treatment options for said medical test result selected;
(d) identifying at least one treatment option from said list of treatment options as a selected treatment option; and
(e) transmitting said selected treatment option to a receiver.

2. The computer-implemented method of claim 1, wherein said medical test result is selected from the group consisting of: blood test results, culture results, hemodynamic monitoring results, and medical lab results.

3. The computer-implemented method of claim 2, wherein each said medical test result is further associated with one or more treatment options.

4. The computer-implemented method of claim 3, wherein said list of treatment options is specifically tailored to addressing data values in said medical test result which may fall outside of a range of normal data values based on accepted medical guidelines.

5. The computer-implemented method of claim 4, wherein said list of treatment options is comprised of treatments selected from the group consisting of: medication, dosage, and route of administration.

6. The computer-implemented method of claim 5, wherein said medical test result is comprised of at least one markup language document selected from the group consisting of: Extensible Markup Language (XML), HyperText Markup Language (HTML), Extensible HyperText Markup Language (XHTML), Geography Markup Language (GML), and Standardized General Markup Language (SGML).

7. The computer-implemented method of claim 1, wherein said interface device is selected from the group consisting of: desktop computer, laptop, cellular telephone, computer tablet, handheld personal device, and electronic display device.

8. The computer-implemented method of claim 1, further including notification means for alerting said healthcare provider to the patient data values in said medical test result which may fall outside of a range of normal data values based on accepted medical guidelines.

9. The computer-implemented method of claim 8, wherein said notification means are visual signals and audible signals.

10. The computer-implemented method of claim 9, wherein said visual signals and audible signals are selected from the group consisting of: font change, data field color change, status descriptions, and system sounds.

11. The computer-implemented method of claim 1, wherein said receiver is selected from the group consisting of: healthcare provider, pharmacy, insurance company, said electronic health record, printer, local server, and remote server.
